(19) United States
(12) Patent Application Publication
(10) Pub. No.: US 2009/0244445 A1
(43) Pub. Date: Oct. 1, 2009

(54) Polarizing Plate and Liquid Crystal Display Device

(75) Inventors: Shun NAKAMURA, Minami-ashigara-shi (JP); Masayoshi TOYODA, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/410,824

(22) Filed: Mar. 25, 2009

(30) Foreign Application Priority Data
Mar. 26, 2008 (JP) 2008-080208

(51) Int. Cl. G02F 1/1335; G02B 1/08; B29C 59/04

(52) U.S. Cl. 349/96; 359/485; 156/189

(57) ABSTRACT

A polarizing plate comprising a polarizer, and a cycloolefin polymer film having a surface bonded to at least one surface of the polarizer, the surface of the cycloolefin polymer film having a mean surface roughness Ra falling within the range from 10 nm to 200 nm, and a shrinkage ratio of the polarizer, after being allowed to stand in an atmosphere at 105° C. for 10 hours, being equal to or smaller than 20% in the direction of transmission axis thereof, is disclosed.

### CROSS-REFERENCE TO RELATED APPLICATIONS

This application claims benefit of priority under 35 U.S.C. 119 to Japanese Patent Application No. 2008-080208 filed on Mar. 26, 2008, which is expressly incorporated herein by reference in its entirety.

### BACKGROUND OF THE INVENTION

1. Technical Field

The present invention relates to a polarizing plate, and a liquid crystal display device provided with the same.

2. Background Art

As optical films used typically for optical compensation of liquid crystal display devices, there have conventionally been known various types of optical compensation films each having a transparent support composed of a polymer film, and an optically anisotropic layer composed of a liquid crystal composition formed thereon (Japanese Patent No. 2587398, for example). As the transparent support, triacetyl cellulose (TAC) film has generally been used.

Liquid crystal display devices adopted to mobile phones, notebook-type personal computers and so forth may be used not only in indoor environments, but also in outdoor environments under various conditions. In particular, in-car liquid crystal display devices may sometimes be exposed to environments under excessively high temperatures. Accordingly, also the polarizing plates used for liquid crystal display devices in these applications are desired to have excellent durability, so as to avoid degradation even under drastic changes in the environmental temperature.

On the other hand, there has been proposed to use cyclic olefin-base films as various types of optical films (see Japanese Laid-Open Patent Publication Nos. 2002-114827, 2005-43740 and 2007-98643, for example).

### SUMMARY OF THE INVENTION

Durability of the polarizing plate is necessarily considered from two viewpoints, one of which relates to reduction in fluctuation in polarizing characteristics depending on environmental moisture, and the other relates to a less possibility of causing separation between the polarizer and a protective film even in high-temperature environments.

It is therefore one object of the present invention to provide a polarizing plate excellent in the durability from both of the above-described viewpoints, and a liquid crystal display device using the same, excellent in the durability.

The present inventors found out after their extensive investigations that the cycloolefin polymer film might be excellent in capability of protecting the polarizer, and use of the film might reduce fluctuation in the polarizing characteristics depending on environmental humidity, but was poor in the adhesiveness with the polarizer, and was likely to cause separation from the polarizer under high-temperature environments. From their further investigations based on these findings, the present inventors found out also that the separation between the polarizer and the cycloolefin polymer film may be less likely to occur, if residual stress at the interface where the polarizer and the protective film are bonded could be reduced, and if the interfacial stress could be dispersed rather than being concentrated in the process of separation. The present invention was conceived after still further investigations based on these findings.

The means for achieving the objects are as follows.

[1] A polarizing plate comprising a polarizer, and a cycloolefin polymer film having a surface bonded to at least one surface of the polarizer, the surface of the cycloolefin polymer film having a mean surface roughness Ra failing within the range from 10 nm to 200 nm, and a shrinkage ratio of the polarizer, after being allowed to stand in an atmosphere at 105° C. for 10 hours, being equal to or smaller than 20% in the direction of transmission axis thereof.
[2] The polarizing plate according to [1], wherein the polarizer and the cycloolefin polymer film are bonded using a poly(vinyl alcohol)-base adhesive, and the adhesive contains at least one species of poly(vinyl alcohol) having acetoacetyl groups, and at least one species of crosslinking agent.
[3] The polarizing plate according to [1] pr [2], further comprising a retardation film bonded to one surface of the polarizer.
[4] The polarizing plate according to [3], wherein said retardation film comprises a transparent base, an alignment film, and an optically anisotropic layer formed of a discotic liquid crystal composition.
[5] The polarizing plate according to [4], wherein said transparent base is a cellulose acylate film.
[6] A liquid crystal display device comprising at least one polarizing plate according to any one of [1] to [5].
[7] The liquid crystal display device according to [6], employing a TN, VA, IPS, or OCB mode.
[8] The liquid crystal display device according to [6] or [7], which is used as a in-car liquid crystal display device.
[9] A process of producing a polarizing plate comprising:

winding up extruded molten material using a casting roll having surface roughness, thereby forming a cycloolefin polymer film having a mean surface roughness Ra falling within the range from 10 nm to 200 nm, and

bonding the surface of the cycloolefin polymer film and a surface of a polarizer film using a polyvinyl alcohol-base additive.

[10] A process of producing a polarizing plate comprising:

winding up extruded molten material using a casting roll while pressing the wind-up film around the casting roll by a touch roll having surface roughness, thereby forming a cycloolefin polymer film having a mean surface roughness Ra falling within the range from 10 nm to 200 nm, and

bonding the surface of the cycloolefin polymer film and a surface of a polarizer film using a polyvinyl alcohol-base additive.

According to the present invention, there is provided a polarizing plate and a liquid crystal display device excellent in the durability. The polarizing plate of the present invention is small in fluctuation in the polarizing characteristics depending on environmental humidity, less causative of degradation such as separation between the polarizer and the protective film even if allowed to stand in high-temperature environments, and is therefore excellent in the durability from two viewpoints described in the above. By using the polarizing plate, also the liquid crystal display device may be improved in the durability, and thereby the liquid crystal display device less causative of fluctuation in the display characteristics or failures ascribable to environmental humidity, and therefore excellent in the durability, may be provided.

### DETAILED DESCRIPTION OF THE INVENTION

Paragraphs below will detail the present invention. Note that any numerical expression in a form of “ . . . to . . . ” in this specification will be used to represent a range including the numerals given before “to” and after “to” as the lower and upper limits, respectively.

### [Polarizing Plate]

The present invention relates to a polarizing plate which includes a polarizer (polarizing film), and a cycloolefin polymer (cyclic olefin-base resin) film having a surface bonded to at least one surface of the polarizer. The surface of the cycloolefin polymer film, bonded to the surface of the polarizer, has a mean surface roughness Ra falling within the range from 10 nm to 200. And, a shrinkage ratio of the polarizer, after being allowed to stand in an atmosphere at 105° C. for 10 hours, is equal to or smaller than 20% in the direction of transmission axis thereof.

The components which can be used in the polarizing plate of the present invention will be explained.

### Polarizer:

In the present invention, a polarizer of which shrinkage ratio of 20% or smaller in the direction of transmission axis thereof, after being allowed to stand in an atmosphere at 105° C. for 10 hours, is used. The polarizer is generally composed of a polymer film such as poly(vinyl alcohol)-base film. The polarizer is generally manufactured in a form of film web, fed in the longitudinal direction, and then wound up in a form of roll. In this specification, the “direction of transmission axis of polarizer” is defined as the direction of feeding. Usually, a polarizer is manufactured according to a process containing a stretching step, and usually, the stretching is carried out in the direction along the transmission axis thereof. As a consequence, such a polarizer is applied with stress in the direction along the transmission axis thereof, so that the polarizer has a tendency of shrinking in the direction along the transmission axis thereof. According to the invention, the interfacial residual stress, which is caused in the process of bonding the polarizer and the protective film, may be reduced by adjusting the shrinkage ratio of the polarizer to the range equal to or smaller than 20%, thereby to prevent the polarizer and the protective film from separating from each other. From this point of view, the shrinkage ratio in the direction along the transmission axis of polarizer is preferably equal to or smaller than 20%, and more preferably equal to or smaller than 15%. From the viewpoint of effect, the lower limit is not specified, wherein better result may be obtained as the shrinkage ratio is reduced closer to 0%. The lower limit value accessible by currently-available materials may be 5% or around.

The shrinkage ratio may be calculated based on the lengths of polarizer in the direction along the transmission axis, measured before and after the polarizer is allowed to stand in an atmosphere at 105° C. for 10 hours. More specifically, the shrinkage ratio may be calculated from the equation below. Note that the atmosphere in the process of heating is kept low in humidity, typically at a relative humidity of 5% RH or lower.

Shrinkage Ratio=[{length of polarizer in the direction of transmission axis before heating−length of polarizer in the direction of transmission axis after heating}/(length of polarizer in the direction of transmission axis before heating)]×100

In terms of material or the like, the polarizer is not specifically limited. Various types of polarizer may be adoptable. Coated-type polarizer such as available from Optiva Inc., or polarizer containing a binder combined with iodine or a dichroic colorant may be preferable. The polarizer will further be explained referring to that containing a binder combined with iodine or a dichroic colorant.

The polarizer of this embodiment may be obtained as follows. A film composed of a polymer composition is prepared, and dipped in a liquid containing iodine or a dichroic colorant, to allow it to infiltrate thereinto so as to dye the film. In terms of imparting a polarizing function, the polymer film may preferably be dyed with iodine or a dichroic colorant, after being stretched.

Examples of the polymer to be used as a major material include poly(methyl methacrylate), poly(acrylic acid), poly(methacrylic acid), polystyrene, poly(vinyl alcohol), modified poly(vinyl alcohol), poly(N-methylol acrylamide), poly(vinyl toluene), chlorosulfonated polyethylene, nitrocellulose, chlorinated polyolefin [e.g., poly(vinyl chloride)], polyester, polyimide, poly(vinyl acetate), polyethylene, carboxymethyl cellulose, polypropylene, polycarbonate, and copolymers of them (e.g., acrylic acid/methacrylic acid copolymer, styrene/maleimide copolymer, styrene/vinyl toluene copolymer, vinyl acetate/vinyl chloride copolymer, ethylene/vinyl acetate copolymer). Also silane coupling agent may be used as the polymer.

Water-soluble polymers [e.g., poly(N-methylol acrylamide), carboxymethyl cellulose, gelatin, poly(vinyl alcohol) and modified poly(vinyl alcohol)] are preferable, and among these gelatin, poly(vinyl alcohol) and modified poly(vinyl alcohol) are more preferable, and poly(vinyl alcohol) and modified poly(vinyl alcohol) are particularly preferable.

The degree of saponification of the poly(vinyl alcohol) and modified poly(vinyl alcohol) is preferably from 70 to 100%, more preferably from 80 to 100%, and particularly preferably from 95 to 100%. The degree of polymerization of poly(vinyl alcohol) is preferably 100 to 5,000.

The modified poly(vinyl alcohol) may be obtained by introducing modifier group into poly(vinyl alcohol), by modification such as copolymerization modification, chain-transfer reaction modification, or block polymerization modification. In the copolymerization modification, COONa, Si(OH)₃, N(CH₃)₃.Cl, C₉H₁₉COO, SO₃Na, or C₁₂H₂₅ may be introduced as the modifier group. In the chain-transfer reaction, the COONa, SH, or SC₁₂H₂₅ may be introduced as the modifier group.

The degree of polymerization of the modified poly(vinyl alcohol) is preferably 100 to 3,000. The modified poly(vinyl alcohol) is described in Japanese Laid-Open Patent Publication Nos. 8-338913, 9-152509, and 9-316127.

Unmodified poly(vinyl alcohol), and alkylthio-modified poly(vinyl alcohol), having degrees of saponification of 85 to 95%, are particularly preferable.

The poly(vinyl alcohol) and the modified poly(vinyl alcohol) may be used in a form of mixture of two or more species.

One or two or more species of these polymers may be used as a binder, so as to produce a polymer film for the polarizer. The above-described binder may be crosslinked. For example, the polymer film may be prepared by using a polymer intrinsically crosslinkable by itself. The polymers may be crosslinked by exposing the polymer having functional groups to light, heat or pH change. The crosslinked structure may be introduced to the polymer also by using a crosslinking agent. The crosslinking agent adoptable herein includes those having large reactivity, and more specifically the compounds described in U.S. Reissue Pat. No. 23297. Also boron compounds (e.g., boric acid, borax) may be adoptable as the crosslinking agent.

The binder may contain an unreacted portion of the crosslinking agent to a certain degree, even after the crosslinking reaction comes to the end. In view of reducing time-dependent fluctuation in the performance, the amount of residual crosslinking agent is preferably equal to or less than 1.0% by mass with respect to the mass of the binder, and more preferably equal to or less than 0.5% by mass.

Next, the polymer film composed of the binder is dyed with iodine or a dichroic colorant. The polymer film may be dyed by immersing it into a liquid containing iodine or a dichroic colorant.

Examples of the dichroic colorant include azo dyes, stilbene dyes, pyrazolone dyes, triphenylmethane dyes, quinoline dyes, oxazine dyes, thiazine dyes and anthraquinone dyes. The dichroic colorant is preferably water-soluble. The dichroic colorant preferably has a hydrophilic substituent (e.g., sulfo, amino, hydroxyl groups).

Examples of the dichroic colorant include C.I. Direct Yellow 12, C.I. Direct Orange 39, C.I. Direct Orange 72, C.I. Direct Red 39, C.I. Direct Red 79, C.I. Direct Red 81, C.I. Direct Red 83, C.I. Direct Red 89, C.I. Direct Violet 48, C.I. Direct Blue 67, C.I. Direct Blue 90, C.I. Direct Green 59, and C.I. Acid Red 37.

The dichroic colorant is described in Japanese Laid-Open Patent Publication Nos. H1-161202, H1-172906, H1-172907, H1-183602, H1-248105, 1-265205 and 7-261024.

The dichroic colorant is used in a form of free acid, or in a form of salt such as alkali metal salt, ammonium salt, amine salt and so forth. Polarizers having various color tones may be prepared by blending two or more species of dichroic colorants. A polarizer using a compound (dye) which looks black, and a polarizer or a polarizing plate having various types dichroic molecules blended therein so that it may look black, when the axes of polarization are aligned normal to each other, are preferable, because they are excellent both in the transmissivity and the degree of polarization expressed by a single plate.

The polarizer is preferably prepared by stretching the film composed of a binder, in the longitudinal direction (in the direction along the transmission axis of polarizer), and then by dying the film with iodine or a dichroic dye. Wet stretching, by which the film is stretched while being immersed in the liquid, is preferable. Conditions of stretching may be determined depending on species of binders and so forth, wherein the stretching magnification ratio (draw ratio) is generally adjusted to the range from 2.5 to 30.0 or around. The shrinkage ratio of the polarizer in the direction along the transmission axis thereof may be controlled to fall in the above-described ranges, also by adjusting the stretching magnification ratio in the stretching step. The polarizer stretched at smaller stretching magnification ratio tends to lower the shrinkage ratio in the direction along the transmission axis thereof, on the other hand, too small stretching magnification ratio may degrade the polarization performances, and may thereby degrade the performances of the polarizing plate. From both of these points of view, the stretching magnification ratio in the wet stretching step is preferably from 4.0 to 10 or around, and particularly preferably from 5.0 to 7.0 or around. The ranges are, however, not limited thereto.

The film may be stretched several times while dividing the process into several steps. The division into several steps allows more uniform stretching. For the case where the multi-step stretching is carried out, the total factor of stretching preferably falls in the above-described ranges. The film is stretched at least in the direction along the transmission axis of polarizer.

### Cycloolefin Polymer Film:

In the present invention, a cycloolefin polymer film is used as a protective film provided at least on one surface of the polarizer. The mean surface roughness Ra of the surface of the cycloolefin polymer film, to be bonded with the polarizer, is from 10 nm to 200 nm. The present inventors found out that, by adjusting the mean surface roughness Ra of the surface of the cycloolefin polymer film to be bonded with the polarizer to the above-described ranges, stress possibly concentrated to the interface between the film and the polarizer may be dispersed, which can prevent them from separating even if exposed to high temperatures. From this point of view, larger value of the mean surface roughness Ra of the surface to be bonded may be more preferable, wherein the value is preferably equal to or larger than 10 nm, and more preferably equal to or larger than 100 nm. On the other hand, too large mean surface roughness may tend to degrade surface condition of the film. From this point of view, the value is preferably equal to or smaller than 200 nm, and more preferably equal to or smaller than 150 nm.

The mean surface roughness Ra of film may be determined similarly to “arithmetic mean roughness Ra” specified by JIS B0601-1994. More specific procedures may be as follow. First, surface condition of the film is measured over a predetermined length (5 mm for example) in the direction vertical to the direction of taking-up of the extruded produce, using a contact-stylus profilometer (JIS B0651), to prepare a measurement curve (also referred to as “profile curve”). The curve is processed with a phase compensation high-pass filter at a cut-off value of 0.8 mm, to thereby obtain a roughness curve. A certain reference length is sampled from the roughness curve in the direction of the average line. Absolute values of deviations from the roughness curve away from the average line in the sampled portion are summed up, and a mean value is calculated.

The mean surface roughness Ra of the film may be adjusted to the above-described ranges by various methods. For example, in an embodiment where the cycloolefin polymer film is prepared according to a melt extrusion method, adjusting is carried out as follows. In this embodiment, the molten material extruded under fusion may generally be cooled while being wound up on a casting roll. By adjusting the surface roughness Ra of the casting roll to be used in this step, the cyclic olefin resin film having Ra fallen in the above-described ranges may be prepared. There is no special limitation on materials for composing the casting roll. The materials may be exemplified by rubber, carbon steel, stainless steel and so forth. The mean surface roughness Ra of the casting roll is preferably from 50 to 600 nm or around. The temperature of the casting roll generally falls within the range from (Tg−30) to (Tg+30)° C. or around, making reference to the glass transition point (Tg) of the resin, and preferably falls within the range from (Tg−20) to (Tg+20)° C. or around.

In another example, the resin wound around the casting roll may sometimes be pressed by a touch roll from the opposite side of the casting roll. The cyclic olefin resin film having Ra in the above-described ranges may be prepared also by adjusting the surface roughness Ra of the touch roll and/or the line pressure of touch. The touch roll generally has a cylindrical form. In order to keep a constant distance of nipping between the touch roll and the casting roll, the line pressure of touch may be controlled by a spring which pushes the touch roll towards the casting roll, a hydraulic piston, and so forth. The surface roughness Ra of the touch roll is preferably from 50 to 1000 nm or around (including the range from 50 to 600 nm around), and the line pressure of touch is preferably from 50 to 200 Kgf/cm, but are not limited to these ranges.

The melt extrusion method for preparing a cycloolefin polymer film, a casting roll applied thereto, and a touch roll are describe in detail in Japanese Laid-Open Patent Publication No. 2000-280315, the content of which may be referable.

The solvent casting method for preparing a cycloolefin polymer film is described in detail in Japanese Laid-Open Patent Publication No. 2007-98643, the content of which may be referable.

Next, the cycloolefin polymer to be used in the invention will be explained. The cycloolefin polymer may be referred also to as “cyclic polyolefin”, hereinafter. The cycloolefin polymer film means a film containing a cyclic polyolefin as a major constituent.

Examples of the cycloolefin polymer include (1) norbornene polymers, (2) polymers of monocyclic olefin, (3) polymers of cyclic conjugation diene, (4) polymer of vinyl alicyclic hydrocarbon, and hydrogenated products of (1) to (4). According to the present invention, preferable examples of the cycloolefin polymer include cyclic polyolefins, obtained by addition (co)polymerization, containing at least one species of repeating unit represented by the formula (I) below, and cyclic polyolefins, obtained by addition (co)polymerization, containing at least one species of repeating unit represented by the formula (I) below and optionally containing at least one species of repeating unit represented by the formula (II) below. Also cyclic polyolefins, obtained by ring-opening (co) polymerization, containing at least one species of repeating unit represented by the formula (III) below, may preferably be used.

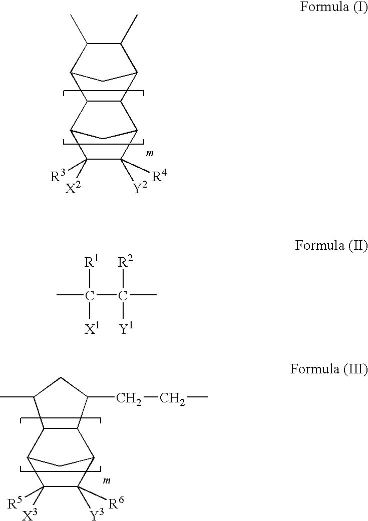

In the formulae (I), (II) and (III), m represents an integer from 0 to 4. Each of R¹ to R⁶ independently represents a hydrogen atom or hydrocarbon group having 1 to 10 carbon atoms, each of X¹ to X³ and Y¹ to Y³ independently represents a hydrogen atom, hydrocarbon group having 1 to 10 carbon atoms, halogen atom, hydrocarbon group substituted by halogen atom(s) having 1 to 10 carbon atoms, —(CH₂)ₙCOOR¹¹, —(CH₂)ₙOCOR¹²—(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or (—CO)₂O or (—CO)₂NR¹⁵ composed of X¹ and Y¹, X² and Y², or X³ and Y³. Each of R¹¹, R¹², R¹³, R¹⁴ and R¹⁵ represents a hydrogen atom or hydrocarbon group having 1 to 20 carbon atoms, Z represents a hydrocarbon group or halogen-substituted hydrocarbon group, W represents SiR¹⁶ₚD₃₋ₚ (R¹⁶ represents a hydrocarbon group having 1 to 10 carbon atoms, D represents a halogen atom, —OCOR¹⁶ or —OR¹⁶, and p represents an integer from 0 to 3), and n represents an integer from 0 to 10.

The thickness-wise retardation (Rth) may be increased and the in-plane retardation (Re) may be made more expressive, by introducing functional group(s) having a large polarity to all of, or a part of X¹ to X³, and Y¹ to Y³. A film highly expressive in Re may be increased in the Re value, by being stretched in the process of film making.

The norbornene-base addition (co)polymers are disclosed in Japanese Laid-Open Patent Publication No. H 10-7732, Published Japanese Translation of PCT International Publication for Patent Application No. 2002-504184, US2004229157A1, WO2004/070463A1, and so forth. They may be obtained by addition polymerization of norbornene-base polycyclic unsaturated compounds. The norbornene-base polycyclic unsaturated compounds may optionally be subjected to addition polymerization with ethylene, propylene or butene; conjugation diene such as butadiene and isoprene; non-conjugation diene such as ethylidene norbornene; or linear diene compound such as acrylonitrile, acrylic acid, methacrylic acid, maleic anhydride, acrylic acid ester, methacrylic acid ester, maleimide, vinyl acetate and vinyl chloride. The norbornene-base addition (co)polymer is commercially available from Mitsui Chemicals, Inc. under the trade name of APEL graded by glass transition temperature (Tg), which includes APL8008T (Tg=70° C.), APL6013T (Tg=125° C.), APL6015T (Tg=145° C.) and so forth. Pellets are available from Polyplastics Co., Ltd. under the trade names of TOPAS8007, TOPAS6013, TOPAS6015 and so forth. Moreover, Appear3000 is available from Ferrania.

The hydrogenated products of norbornene polymers are prepared by subjecting polycyclic unsaturated compounds to addition polymerization or ring-opening methathesis polymerization, followed by hydrogen addition, as disclosed in Japanese Laid-Open Patent Publication Nos. H1-240517, H7-196736, S60-26024, S62-19801, 2003-1159767 and 2004-309979. In the norbornene polymers used in the present invention, each of R⁵ and R⁶ is preferably a hydrogen atom or —CH₃; each of X³ and Y³ is preferably a hydrogen atom, Cl or —COOCH₃; and the other groups may appropriately be selected. The norbornene resins are available from JSR Corporation under the trade names of Arton G and Arton F, and also from Zeon Corporation under the trade names of Zeonor ZF14, ZF16, Zeonex 250 and Zeonex 280, all of which may be adoptable.

The cycloolefin polymer film contains one species, or two or more species of the above-described cyclic polyolefins as a major constituent, and optionally contains additive(s). Examples of the additives include anti-degradation agent, UV absorber, retardation (optical anisotropy) adjusting agent, matting agent particle, release aid, infrared absorber and so forth.

Examples of the anti-degradation (antioxidant) agent which can be used in the invention include phenolic- or hydroquinone-antioxidants such as 2,6-di-t-butyl-4-methyl phenol, 4,4′-thiobis-(6-t-butyl-3-methyl phenol), 1,1′-bis (4-hydroxy phenyl)cyclohexane, 2,2′-methylene bis(4-ethyl-6-t-butyl phenol), 2,5-di-t-butyl hydroquinone, and pentaerythrityl-tetrakis[3-(3,5-di-t-butyl-4-hydroxy phenyl)propionate. Examples of that include also phosphorous antioxidants such as tris(4-methoxy-3,5-diphenyl)phosphite, tris(nonyl phenyl)phosphite, tris (2,4-di-t-butylphenyl)phosphite, bis(2,6-di-t-butyl-4-methylphenyl) pentaerythritol diphosphite, and bis(2,4-di-t-butylphenyl)pentaerythritol diphosphite. The amount of the antioxidant to be added to the composition is preferably from 0.05 to 5.0 parts by mass with respect to 100 parts by mass of cyclic polyolefin.

Examples of the UV absorber which can be used in the invention include hindered phenol compounds, oxybenzophenone compounds, benzotriazole compounds, salicylate compounds, benzophenone compounds, cyanoacrylate compounds, and nickel complex compounds. Examples of the hindered-phenol type UV absorber include 2,6-di-tert-butyl-p-cresol, N,N′-hexamethylenebis (3,5-di-tert-butyl-4-hydroxy-hydro cinnamide), 1,3,5-trimethyl-2,4,6-tris (3,5-di-tert-butyl-4-hydroxybenzyl)benzene, and tris-(3,5-di-tert-butyl-4-hydroxy benzyl)-isocyanurate. Examples of the benzotriazole-type UV absorber usable in the invention include 2-(2′-hydroxy-5′-methylphenyl)benzotriazole, 2,2-methylenebis(4-(1,1,3,3-tetramethylbutyl)-6-(2H-benzotriazol-2-yl)phenol, (2,4-bis-(n-octylthio)-6-(4-hydroxy-3,5-di-tert-butyl anilino)-1,3,5-triazine, triethyleneglycol-bis[3-(3-tert-butyl-5-methyl-4-hydroxyphenyl)propionate], 2(2′-hydroxy-3′,5′-di-tert-butylphenyl)-5-chlorobenzotriazole, and (2(2′-hydroxy-3′,5′-di-tert-amyl phenyl)-5-chlorobenzotriazole, 2,6-di-tert-butyl-p-cresol.

The mass of the UV absorber to be added to the composition is preferably from 1 ppm to 1.0% and more preferably from 10 to 1000 ppm with respect to the mass of cyclic polyolefin

The matting agent particle is added typically so as to provide an irregularity to the film surface, for the purpose of improving poor slipping property of the film surface. Examples of the particle include inorganic compound particle or polymer particle having a mean particle size of 0.1 μm to 3.0 μm, more preferably 0.15 μm to 2.0 μm, and still more preferably 0.2 μm to 1.0 μm. Examples of the matting agent composed of inorganic compound include fine particles of inorganic compounds such as barium sulfate, manganese colloid, titanium dioxide, strontium barium sulfate and silicon dioxide. Examples of the matting agent composed of polymer compound include fine particles of poly(tetrafluoroethylene), cellulose acetate, polystyrene, poly(methyl methacrylate), poly(propyl methacrylate), poly methacrylate, polyethylene carbonate and starch.

The cycloolefin polymer film used in the present invention may be stretched by monoaxial stretching in the longitudinal (mechanical) or transverse direction, or by biaxial stretching.

The cycloolefin polymer film may be subjected also to surface treatment on the surface thereof to be bonded with the polarizer, for the purpose of improving adhesiveness with the polarizer. The surface treatment may preferably be corona discharge treatment or atmospheric pressure plasma treatment. Although the corona discharge treatment may be classified into the atmospheric-pressure plasma in a broad sense, it is defined in this description that the treatment by which an object is directly exposed to a plasma excited region raised by corona discharge is referred to as corona discharge treatment, and that the treatment by which an object is placed apart from the plasma excited region is referred to as atmospheric-pressure plasma treatment. The corona treatment is advantageous in that it is well proven in the industrial applications while needing only a low cost, but is disadvantageous in that the surface of the object may physically be damaged to a larger degree. On the other hand, the atmospheric-pressure plasma treatment is advantageous in that the surface of the object may be damaged only to a smaller degree and thereby the intensity of treatment may be set to a relatively larger degree, although it has been proven only by relatively limited applications, and the cost of which is higher than that of the corona discharge treatment. Accordingly, more preferable one of the both may be selected, taking trade-off between the damage of the polymer film adopted herein and the level of improvement in the adhesiveness after the treatment, into consideration.

The thickness of the cycloolefin polymer film which can be used in the present invention is preferably from 30 to 200 μm or around, and more preferably from 40 to 80 μm, without special limitation.

### Adhesive:

An adhesive may be used for bonding the cycloolefin polymer film to the polarizer. Materials composing the adhesive layer may be exemplified by known adhesive, pressure-sensitive adhesive, anchor coat material and so forth. The adhesive layer may have a multi-layered structure such as having an anchor coat layer formed on an object, and having an adhesive layer formed further thereon, or may be formed using a ultraviolet-curable adhesive. The poly(vinyl alcohol)-base adhesives are widely used as the adhesive, by virtue of their desirable adhesiveness and easy handling, and contain one species, or two or more species selected from unmodified and modified poly(vinyl alcohol)s as major constituent, and optionally contain one species, or two species or more crosslinking agents capable of crosslinking poly(vinyl alcohol)s. Examples of modifier group(s) of the modified poly(vinyl alcohol) include acetoacetyl group, sulfonic acid group, carboxyl group and oxyalkylene group. The polarizer and the cycloolefin polymer film may be bonded preferably by using an adhesive containing at least one species of poly(vinyl alcohol) having acetoacetyl groups, and at least one species of crosslinking agent, wherein hexamethylenediamine is preferably used as the crosslinking agent.

The thickness in the dried state of the adhesive layer between the polarizer and the cycloolefin polymer film preferably falls in the range from 0.01 to 10 μm, and more preferably from 0.05 to 5 μm.

The polarizing plate of the present invention has the cycloolefin polymer film as a protective film, on at least one surface of the polarizer. Of course, the polarizing plate may have the cycloolefin polymer film as a protective film on both surfaces. One example of the polarizing plate of the present invention is an elliptic polarizing plate having a polarizer, the cycloolefin polymer film disposed on one surface of the polarizer, and a retardation film disposed on the other surface of the polarizer. The polarizing plate of the embodiment is adoptable to liquid crystal display devices; and in such an embodiment, the polarizing plate is preferably arranged so that the retardation film is disposed inside, that is at the liquid crystal cell side.

One example of the retardation film is such as having a transparent base, an alignment film, and an optically anisotropic layer composed of a discotic liquid crystal composition. In an embodiment using this sort of retardation film as a protective film, it may be preferable to bond the surface of the polarizer, and the back surface of the transparent base (the surface having no alignment film and optically anisotropic layer formed thereon). Various types of polymer film may be adoptable to the transparent base, wherein the cycloolefin polymer film may, of course, be adoptable. Among others, cellulose acylate film, having conventionally been used generally as the protective film for the polarizer, may preferably be used.

One example of the optically anisotropic layer is a layer formed by curing a composition containing a liquid crystal, selected from rod-like liquid crystal or discotic liquid crystal. The liquid crystal is fixed to a predetermined alignment after being cured by polymerization reaction, crosslinking reaction and so forth, and is supposed to lose liquid crystallinity in the optically anisotropic layer. Adoptable liquid crystal is, therefore, not specifically limited, instead allowing use of any rod-like and discotic liquid crystals described in various literatures. In view of obtaining the composition in a form of light-curable or thermosetting one, a polymerizable liquid crystal may be used together with a photo-polymerization initiator or heat polymerization initiator.

One exemplary method of forming the optically anisotropic layer is as follows. A coating liquid which contains a liquid crystal and a polymerization initiator is prepared, applied to the surface, dried to achieve a predetermined state of alignment, and polymerized under irradiation of light or heating. According to this method, the optically anisotropic layer showing various optical characteristics ascribable to alignment of the liquid crystal may be formed.

The alignment film is used for preparing the optically anisotropic layer. The alignment film may be prepared as follows. A poly(vinyl alcohol) film, polyimide film or the like is prepared typically by coating the material to the surface of a transparent base, and then the surface of the film is rubbed.

### [Liquid Crystal Display Device]

The liquid crystal display device of the present invention has at least one polarizing plate of the present invention. A reflection-type liquid crystal display device generally has polarizing plates disposed on the observer's side and on the backlight side of a liquid crystal cell. Both polarizing plates may preferably be the polarizing plates of the present invention from the viewpoint of effect.

The display mode of the liquid crystal display device of the present invention is not specifically limited. The effect of the present invention may be obtainable for any modes including TN (Twisted Nematic) mode employing twisted alignment; and VA (Vertically Aligned), IPS (In-plane Switching) and OCB (Optically Compensated Birefringence) modes without employing twisted alignment. Since the polarizing plate of the present invention is less causative of separation between the polarizer and the protective film even if being exposed to high temperatures, the polarizing plate is useful in particular for in-car liquid crystal display devices possibly exposed to drastic elevation in temperature.

### Example

Paragraphs below will further specifically explain the present invention referring to Examples. Note that any materials, amount of use, ratio, process details, and process procedures shown in Examples below may appropriately be modified, without departing from the spirit of the present invention. Therefore, the scope of the present invention is by no means limited to the specific examples described below.

### 1. Preparing Polarizer

Polarizers A to C were respectively prepared according to the method below.

A 75-μm-thick poly(vinyl alcohol) film having a mean degree of polymerization of 2400, and a degree of saponification of 99.9 mol % was immersed into warm water at 30° C. for 60 seconds so as to allow the film to swell. Next, the film was immersed in a 0.3% aqueous iodine/potassium iodide (ratio by mass=0.5/8) solution, and the film was dyed while stretching it by a factor of 3.5. Thereafter, the film was stretched by a total factor of 5.0, while keeping it immersed in an aqueous borate ester solution at 65° C. After the stretching, the film was dried in an oven at 40° C. for 3 minutes, to thereby obtain a polarizer. The polarizer was used as Polarizer“A”. Polarizer“A” annealed at 105° C. for 10 hours showed a shrinkage ratio of 5% in the direction along the transmission axis of the polarizer.

Polarizer “B” was prepare in the same manner as Polarizer “A”, except that the total factor of stretching was set to 6.0. Polarizer “B”, annealed under the conditions identical to those in the above, showed a shrinkage ratio of 15% in the direction along the transmission axis of the polarizer.

Polarizer “C” was prepared in the same manner as Polarizer “A”, except that the total factor of stretching was set to 7.0. Polarizer “C”, annealed under the conditions identical to those in the above, showed a shrinkage ratio of 25% in the direction along the transmission axis of the polarizer.

### 2. Preparing Cycloolefin Polymer Film

Cycloolefin polymer (COC) films “A” to “D” were prepared respectively by the methods below.

One hundred parts by mass of cyclic olefin resin, which is a hydrogen-added product of a ring-opening polymer containing 85% by mass of dicyclopentadiene and 15% by mass of ethyl tetracyclododecene, having a weight-average molecular weight (Mw) of 52,600, a content of components having molecular weight of 1,000 or smaller of 0.5% by mass, a ratio of hydrogen addition of polymer (measured by ¹H-NMR) of 99.9%, a glass transition temperature (measured by DSC) of 103° C., a 5% heating limit temperature of 375° C. and a melt viscosity at 260° C. of 2×10³ poise was added with 0.2 parts by mass of phenol-base compound [pentaerythrityl-tetrakis(3-(3,5-di-tert-butyl-4-hydroxyphenyl)propionate)] as an antioxidant, using a double-screw kneader, to produce a pellet-form molding material (490K).

Using the pellet, a sheet was formed using a melt extrusion sheet forming machine (single-screw extruder). Conditions of preparing are shown below. Only a casting roll was used as a winding means. A touch roll, to be brought into contact with the resin taken up onto the casting roll from the opposite side of the casting roll, was also arranged, so as to make the line pressure of touch adjustable. The peel strength at the lip portion of a T-die was measured by a measuring instrument TCM500, using a test piece having the surface same as that of the lip portion.

Screw: metering type

Melt temperature of resin: 260° C.

Die: T-die (material of lip portion: WC, mean roughness Ra=0.14 μm; peel strength=35 N)

Thickness of sheet: 100 μm

Mean surface roughness Ra of casting roll: 0.05 μm

Temperature of casting roll: 145° C.

Mean surface roughness Ra of touch roll: 70 nm

Temperature of touch roll: 130° C.

Line pressure of touch: 100 kgf/cm

COC film “A” was prepared in this way. The mean surface roughness Ra of COC film “A” was found to be 5 nm.

COC film “B” was prepared in the same manner as COC film “A”, except that a roll having a mean surface roughness Ra of 140 nm was used as the touch roll, and the line pressure of touch was adjusted to 100 Kgf/cm. The mean surface roughness Ra of COC film “B” was found to be 15 nm.

COC film “C” was prepared in the same manner as COC film “A”, except that a roll having a mean surface roughness Ra of 800 nm was used as the touch roll, and the line pressure of touch was adjusted to 100 Kgf/cm. The mean surface roughness Ra of COC film “C” was found to be 180 nm.

COC film “D” was prepared in the same manner as COC film “A”, except that a roll having a mean surface roughness Ra of 800 nm was used as the touch roll, and the line pressure of touch was adjusted to 200 Kgf/cm. The mean surface roughness Ra of COC film “D” was found to be 230 nm.

### 3. Preparation of Adhesive

Adhesives A and B described below were prepared.

A resin solution (5% aqueous solution) containing only PVA (degree of polymerization=1700, degree of saponification=98 mol %) was prepared, and was used as Adhesive “A”.

A resin solution (an aqueous solution having the resin concentration adjusted to 5%) containing a modified PVA containing 100 parts by mass of acetoactyl (AA) groups (degree of polymerization=1700, degree of saponification=88 mol %, degree of acetoacetylation=6 mol %), and 10 parts by mass of hexamethylenediamine was prepared, and was used as Adhesive “B”.

### 4. Preparing Polarizing Plate

On both surfaces of any one of Polarizers “A” to “C”, any one of COC films “A” to “D” was bonded using Adhesive “A” or “B”, to thereby prepare each polarizing plate. Combinations of these components were listed in Table below. Each polarizing plate was prepared by applying Adhesive “A” or “B” to surfaces of any one of COC films “A” to “D” to as thick as 0.5 μm on the dry basis, bonding them to both surfaces of each polarizer, and annealing them in a hot air dryer at 50° C. for 5 minutes.

Also the base film side of Retardation Film “A” prepared as below was bonded to the COC film side of the polarizing plate used in Example 6 shown in Table below, to thereby obtain a polarizing plate of Example 7 having a retardation film attached thereto.

### <Preparation of Retardation Film “A”><<Preparation of Base Film>>

The ingredients below was placed in a mixing tank, stirred under heating to melt the individual ingredients, to thereby prepare a cellulose acetate solution “B”.

### Formulation of Cellulose Acetate Solution:

| | |
|---|---|
| Cellulose acetate having a degree of acetylation | 100 parts by mass |
| of 60.9% | |
| Triphenyl phosphate | 7.8 parts by mass |
| Biphenyl diphenyl phosphate | 3.9 parts by mass |
| Methylene chloride | 300 parts by mass |
| Methanol | 45 parts by mass |

To 470 parts by mass of the cellulose acetate solution, 18.5 parts by mass of a solution of the retardation enhancing agent was mixed, and the mixture was thoroughly stirred to prepare a dope. The ratio by mass of the retardation enhancing agent to cellulose acetate was 3.5%. The film having a residual solvent content of 35% by mass was separated from the band, transversely stretched by a stretching magnification ratio of 25% at 140° C. using a film tenter, released from the clips, and dried at 130° C. for 45 seconds, to thereby prepare a cellulose acetate film. Thus-obtained cellulose acetate film was found to have a residual solvent content of 0.2% by mass, and a thickness of 88 μm. This film was used as a base film.

### <Saponification of Base Film>

On one surface of thus-prepared base film, a 1.5-N potassium hydroxide solution in isopropyl alcohol was coated to as much as 25 mL/m², the product was allowed to stand at 25° C. for 5 seconds, washed with running water for 10 seconds, and blown by air at 25° C. to dry the surface thereof. In this way, only one surface of the base film was saponified.

### <Formation of Alignment Layer>

On one surface of the base film thus saponified, a coating liquid for forming alignment layer having the composition below was coated using a #14 wire bar coater to as much as 24 mL/m². The layer was dried under air blow at 60° C. for 60 seconds, and further under air blow at 90° C. for 150 seconds.

Next, thus-formed layer was rubbed in the direction 45° away from the direction of stretching (almost coincides with the slow axis) of the base film.

### Formulation of Coating Liquid for Forming Alignment Film:

| | | |
|---|---|---|
| Modified poly(vinyl alcohol) shown below | 10 | parts by mass |
| Water | 371 | parts by mass |
| Methanol | 119 | parts by mass |
| Glutaraldehyde (crosslinking agent) | 0.5 | parts by mass |

Modified poly(vinyl alcohol)

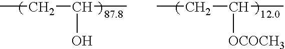

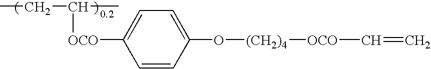

### <Formation of Optically Anisotropic Layer>

Ninety-one parts by mass of a discotic compound, 9 parts by mass of ethylene oxide-modified trimethylolpropane acrylate (V#360, from Osaka Organic Chemical Industry, Ltd.), 0.5 parts by mass of cellulose acetate butyrate (CAB531-1, from Eastman Chemical Company), 3 parts by mass of photo-polymerization initiator (Irgacure 907, from CIBA-GEIGY K.K.), and 1 part by mass of sensitizer (Kayacure DETX, from Nippon Kayaku Co., Ltd.) were dissolved into 204.0 parts by mass of methyl ethyl ketone, to thereby prepare a coating liquid.

The coating liquid was applied to the rubbed surface of the alignment layer using a #3.2 wire bar to as much as 5.52 mL/m². The film was then spread onto a metal frame, and heated in a thermostat chamber at 130° C. for 2 minutes, to thereby align the discotic compound.

Next, the discotic compound was allowed to polymerize at 90° C. under UV irradiation for 4 seconds using a 120-W/cm high pressure mercury lamp. The layer was then cooled down to room temperature. An optically anisotropic layer was formed in this way, to thereby prepare a retardation film. This was used as Retardation film “A” in Example 7.

### Discotic Liquid Crystalline Compound Poly(Vinyl Alcohol)

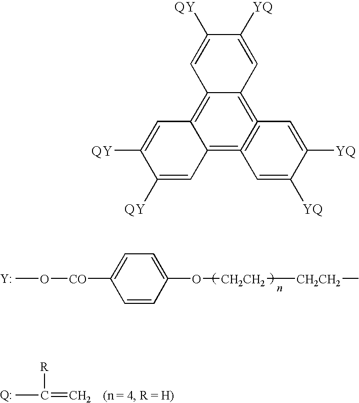

### 5. Preparation of Liquid Crystal Cell

### (Preparation of Bend-Aligned Liquid Crystal Cell)

Each of two glass substrates having an ITO electrode formed thereon was provided with a polyimide film as an alignment film, and the alignment film was rubbed. Two thus-obtained glass substrates were opposed so as to align the direction of rubbing in parallel with each other, while adjusting the width of a gap formed therebetween to 7.2 μm. The gap composing the liquid crystal cell was filled with a liquid-crystalline compound (ZLI1132, from MERCK) having a Δn value of 0.1396, to thereby manufacture a bend-aligned liquid crystal cell “A” having a Δnd value of 1005 nm.

### 6. Preparation of Liquid Crystal Display Device

The bend-aligned liquid crystal cell, Cell “A”, and the polarizing plates prepared in Example 7, Polarizing plate 7, were combined, to thereby prepare a liquid crystal display device.

The liquid crystal cell, Cell “A”, and a pair of the polarizing plates were arranged so as to bond the optically anisotropic layer side of each polarizing plate and the substrates of the liquid crystal cell, and so as to align the direction of rubbing of the liquid crystal cell and the direction of rubbing of the optically anisotropic layers opposed thereto in an anti-parallel manner. A 20-inch liquid crystal display device was thus prepared.

### 7. Evaluation of Polarizing Plate

### 7-1 Durability Test

### High-Temperature Dry Test:

The individual polarizing plates were allowed to stand in a thermostat chamber at 105° C. for 480 hours, and were evaluated in terms of durability by studying separation between the polarizers and the protective films.

### High-Temperature, High-Humidity Test:

The individual polarizing plates were allowed to stand in a thermostat chamber conditioned at a temperature of 85° C. and a relative humidity of 90% for 480 hours, and were evaluated in terms of durability by studying separation between the polarizers and the protective films.

In both tests, evaluation criteria for the durability are as follow:
⊚: No separation observed;
◯: Slight separation observed, but not problematic;
Δ: Separation observed, but practically acceptable; and
X: Notable separation, not acceptable for applications in need of high durability.

### 7-2 Evaluation of Surface Condition

Surface conditions of the individual polarizing plates were evaluated, while placing the polarizing plates on a schaukasten so as to normally cross the transmission axes of the polarizing plates. Evaluation criteria are as follow:
◯: No degradation in surface conditions visually recognizable; and
X: Straight-line streaks and so forth visually recognizable, indicating poor surface conditions.

TABLE 1

| | | | | | | | Durability | | |
|---|---|---|---|---|---|---|---|---|---|
| | | | | | | | | High | |
| | | | Polarizer | | Adhesive | | High | temperature | |
| | COC film | | | Shrinkage | | AA | temperature | and high | Surface |
| | Type | Ra | Type | Ratio | Type | group | and dry | humidity | conditions |
| Example 1 | B | 15 nm | A | 5% | A | no | ◯ | ◯ | ◯ |
| Example 2 | B | 15 nm | B | 15% | A | no | Δ | Δ | ◯ |
| Comparative | B | 15 nm | C | 25% | A | no | X | X | ◯ |
| Example 1 | | | | | | | | | |
| Example 3 | C | 180 nm | A | 5% | A | no | ◯ | ◯ | ◯ |
| Example 4 | C | 180 nm | B | 15% | A | no | ◯ | Δ | ◯ |
| Comparative | C | 180 nm | C | 25% | A | no | Δ | X | ◯ |
| Example 2 | | | | | | | | | |
| Comparative | A | 5 nm | A | 5% | A | no | X | X | ◯ |
| Example 3 | | | | | | | | | |
| Comparative | D | 230 nm | A | 5% | A | no | ◯ | ◯ | X |
| Example 4 | | | | | | | | | |
| Comparative | D | 230 nm | B | 15% | A | no | ◯ | ◯ | X |
| Example 5 | | | | | | | | | |
| Example 5 | B | 130 nm | A | 5% | B | yes | ⊚ | ⊚ | ◯ |
| Example 6 | B | 130 nm | B | 15% | B | yes | ⊚ | ⊚ | ◯ |
| Example 7 | B | 130 nm | B | 15% | B | yes | ⊚ | ⊚ | ◯ |
| | | | | | | | Panel | Panel | Panel |
| | | | | | | | confirmed | confirmed | confirmed |

It may be understood from the results shown in the above, that the polarizing plates of the present invention were less causative of separation between the polarizer and the protective film, even after being allowed to stand under both environments of high-temperature-dry, and high-temperature-high-humidity, and were therefore excellent in the durability. The polarizing plates of the present invention are particularly useful when applied to in-car liquid crystal display devices likely to be exposed to high temperatures.

What is claimed is:

1. A polarizing plate comprising a polarizer, and a cycloolefin polymer film having a surface bonded to at least one surface of the polarizer, the surface of the cycloolefin polymer film having a mean surface roughness Ra falling within the range from 10 nm to 200 nm, and a shrinkage ratio of the polarizer, after being allowed to stand in an atmosphere at 105° C. for 10 hours, being equal to or smaller than 20% in the direction of transmission axis thereof.

2. The polarizing plate of claim 1, wherein the polarizer and the cycloolefin polymer film are bonded using a poly(vinyl alcohol)-base adhesive, and the adhesive contains at least one species of poly(vinyl alcohol) having acetoacetyl groups, and at least one species of crosslinking agent.

3. The polarizing plate of claim 1, further comprising a retardation film bonded to one surface of the polarizer.

4. The polarizing plate of claim 3, wherein said retardation film comprises a transparent base, an alignment film, and an optically anisotropic layer formed of a discotic liquid crystal composition.

5. The polarizing plate of claim 4, wherein said transparent base is a cellulose acylate film.

6. A liquid crystal display device comprising at least one polarizing plate of claim 1.

7. The liquid crystal display device of claim 6, employing a TN, VA, IPS, or OCB mode.

8. The liquid crystal display device of claim 6, which is used as a in-car liquid crystal display device.

9. A process of producing a polarizing plate comprising:
winding up extruded molten material using a casting roll having surface roughness, thereby forming a cycloolefin polymer film having a mean surface roughness Ra falling within the range from 10 nm to 200 nm, and
bonding the surface of the cycloolefin polymer film and a surface of a polarizer using a polyvinyl alcohol-base additive.

10. A process of producing a polarizing plate comprising:
winding up extruded molten material using a casting roll while pressing the wind-up film around the casting roll by a touch roll, having surface roughness, from the opposite side of the casting roll, thereby forming a cycloolefin polymer film having a mean surface roughness Ra falling within the range from 10 nm to 200 nm, and
bonding the surface of the cycloolefin polymer film and a surface of a polarizer film using a polyvinyl alcohol-base additive.
